(19) United States
(12) Patent Application Publication
(10) Pub. No.: US 2013/0152038 A1
(43) Pub. Date: Jun. 13, 2013

(54) PROJECT MANAGEMENT WORKFLOWS

(71) Applicants: JongHwa Lim, Seoul (KR); Samuel Chung, (US); Yong Jin Kim, Seoul (KR); Soo Youn Cho, Seoul (KR); Duhoi Heo, Seoul (KR); Chang Youl Hong, Seoul (KR); Jun Yong Kim, Seoul (KR); Daniel Broekman, Bellevue, WA (US); Ina Teegan, Bellevue, WA (US); John Thoni, (US)

(72) Inventors: JongHwa Lim, Seoul (KR); Samuel Chung, (US); Yong Jin Kim, Seoul (KR); Soo Youn Cho, Seoul (KR); Duhoi Heo, Seoul (KR); Chang Youl Hong, Seoul (KR); Jun Yong Kim, Seoul (KR); Daniel Broekman, Bellevue, WA (US); Ina Teegan, Bellevue, WA (US); John Thoni, (US)

(73) Assignee: MICROSOFT CORPORATION, Redmond, WA (US)

(21) Appl. No.: 13/316,256

(22) Filed: Dec. 9, 2011

(51) Int. Cl. G06F 9/44

(52) U.S. Cl. 717/101

(57) ABSTRACT

A system includes a workflow design application further including a user interface for displaying at least one project server platform type available for selection, and a project mode module configured to retrieve at least one available customizable project workflow component from the project server via a project server application programming interface (API). The user interface is configured to receive a project server platform type selection via the user interface, and, upon receiving the project server platform type selection, display the retrieved at least one customizable project workflow component, receive at least one customizable project workflow component selection, receive a customization selection for the selected customizable project workflow component, and receive a request to generate at least a portion of a project workflow based on the customization selection for the selected customizable project workflow component.

### CROSS-REFERENCE TO RELATED APPLICATIONS

The present application incorporates by reference in their entirety, Application Attorney Docket No. 14917.1903US01/333726.01, U.S. patent application Ser. No. 13/316,108, entitled INTEGRATED WORKFLOW VISUALIZATION AND EDITING, filed Dec. 9, 2011, and Application Docket Number 14917.1965USI1/334166.01, U.S. patent application Ser. No. 13/316,112, entitled STAGE AND STAGE VIEW WITHIN A WORKFLOW, filed Dec. 9, 2011, which are incorporated by reference in their entirety.

### BACKGROUND

Project workflows are computer-implemented workflows that, among other things, assist in the management of project proposals and portfolio analyses. Project workflows are typically created using a specialized project workflow design tool connected to a project server that stores and maintains project data.

It is with respect to this general field of technology that the present application is directed.

### SUMMARY OF THE INVENTION

Embodiments for providing project workflow creation in a workflow design application are herein disclosed.

Project workflow creation is provided using a declarative or visual workflow design application. A connection between the workflow design application and a project server site is provided. The workflow design application may receive project parameters and implement the project workflow. The creation of a project workflow using a workflow design application connected to a project server site enables project workflow via a web application platform without relying on GUIDs to access objects within the project server site.

An embodiment includes a system for creating a project workflow in a web application platform using a workflow design application. The system includes a workflow design application capable of creating a workflow within a web application platform tool, further including: a user interface for displaying, and receiving selection of, at least one project server platform type available for selection; and a project mode module configured to retrieve at least one available customizable project workflow component from the project server via a project server application programming interface (API), wherein the user interface is configured to display the retrieved at least one customizable project workflow component, receive at least one customizable project workflow component selection, receive a customization selection for the selected customizable project workflow component, and receive a request to generate at least a portion of a project workflow based on the customization selection for the selected customizable project workflow component.

In another embodiment, a method for creating a project workflow in a workflow design application is disclosed. The method includes displaying a selectable project server platform type in a user interface of the workflow design application, wherein the at least one selectable project server platform type relates to a project server, and wherein the workflow design application is separate from the project server; upon receiving a selection of the project server platform type via the user interface, receiving at least one customizable project workflow component from an application programming interface (API) of the project server; displaying the at least one customizable project workflow component via the user interface; receiving a selection of at least one customizable project workflow component; receiving a customization selection for the selected customizable project workflow component; and generating at least a portion of a project workflow based on the customization selection for the selected customizable project workflow component.

In another embodiment, a computer-readable medium including executable instructions that, when executed by a processor, create a project workflow in a web application platform using a workflow design application is disclosed. The computer-readable medium including executable instructions that, when executed by a processor, provide project workflow creation, by displaying a selectable project server platform type among one or more non-project server platform types in a user interface of the workflow design application, wherein the at least one selectable project server platform type relates to a project server, and wherein the workflow design application is separate from the project server; upon receiving a selection of the project server platform type via the user interface, receiving at least one customizable project workflow component from an application programming interface (API) of the project server; displaying the at least one customizable project workflow component via the user interface; receiving a selection of at least one customizable project workflow component; receiving a customization selection for the selected customizable project workflow component; generating at least a portion of a project workflow based on the customization selection for the selected customizable project workflow component; and publishing the project workflow portion to a web application platform to allow manipulation of the project workflow portion within a web application platform.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

Referring now to the drawings in which like reference numbers represent corresponding parts throughout:

FIG. 1 illustrates the high level architecture of a system for creating a project workflow according to one embodiment;

FIG. 2 illustrates a user interface for creating a project workflow according to one embodiment;

FIG. 3 shows user interface components for displaying selectable project stages fetched from the project server according to one embodiment;

FIG. 4 shows sentence based project workflow logics for setting stage parameters according to one embodiment;

FIG. 5 shows user interface components for displaying selectable action items including one or more project action items according to one embodiment;

FIG. 6 shows a project workflow lookup module according to one embodiment;

FIG. 7 illustrates project workflow visualization according to one embodiment;

FIG. 8 is a flow diagram of a method for creating a project workflow according to one embodiment;

FIG. 9 is a flow diagram of a method for creating a project workflow according to one embodiment; and

FIG. 10 is a simplified block diagram of a computing system in which embodiments of the present invention may be practiced.

### DETAILED DESCRIPTION

Embodiments of the present invention provide project workflow creation using a declarative or visual workflow design application. A connection between the workflow design application and a server storing project data for one or more project workflows (hereinafter a “project server”) is provided. Using the workflow design application, a user may set and edit project parameters to implement the project workflow. The creation of a project workflow using a general purpose workflow design application connected to a project server site enables a user to create project workflows via a web application platform without relying on GUIDs to access objects within the project server.

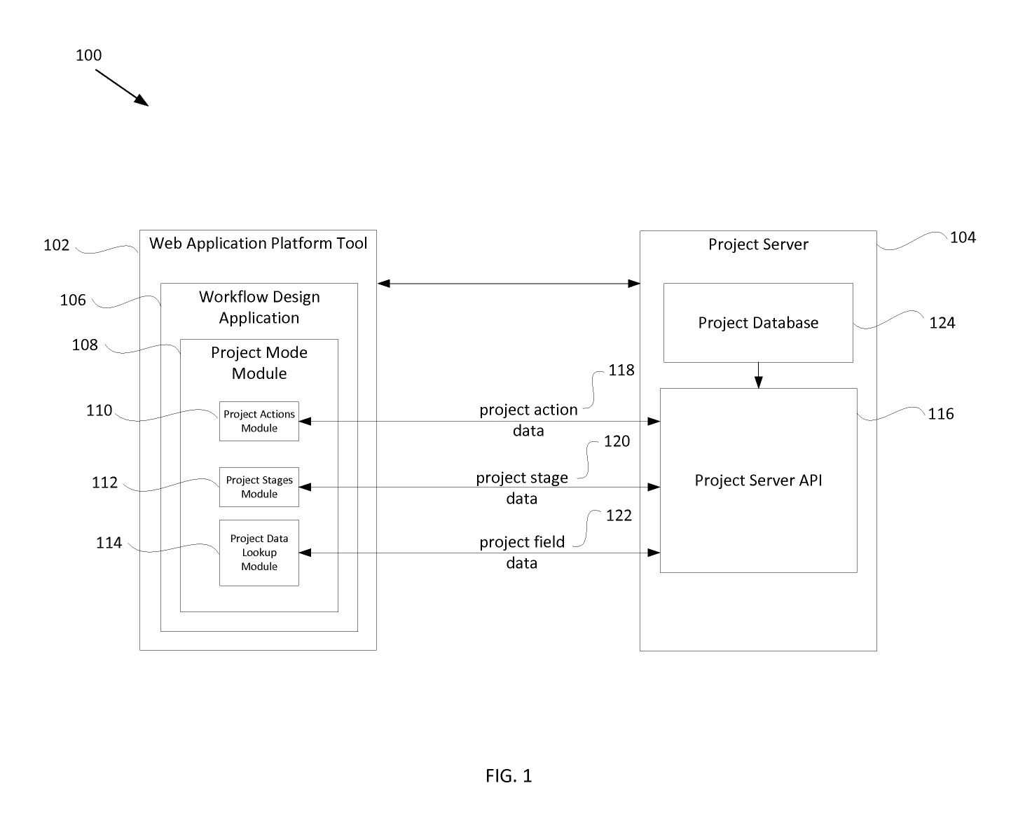

FIG. 1 illustrates the high level architecture of a system 100 for creating a project workflow according to one embodiment. A project workflow may include a series of project tasks or project actions, the order in which the project tasks are performed, permissions defining who can perform the project tasks, and script that is executed for each project action. The system 100 includes a web application platform tool 102 further including a workflow design application 106. The workflow design application 106 may be a general purpose workflow design application typically used to create workflows not related to projects. Workflow design application 106 may, in embodiments, be adapted to include additional functionality for accessing a project server and receiving project data from the project server to generate a project workflow.

Workflow design application 106 may be a component in the design infrastructure of the web application platform tool 102 that creates workflows, such as in this instance, project workflows. The workflow design application 106 may create one or more project workflow definitions, and may publish the one or more definitions to a project server 104. The project server 104 (or a separate application management service, such as Microsoft® AppFabric, may then enforce the project workflow definitions and execute project workflow actions. Workflow design application 106 may be a declarative workflow design application. A declarative workflow design application is an application that enables a user to design a workflow using text based or natural language sentences that express business process tasks performed by activities. To this end, the declarative workflow design application may be capable of generating visible user interface (UI) elements using a declarative markup language, such as Extensible Application Markup Language (XAML). The Extensible Application Markup Language is a declarative Extensible Markup Language—based language. A declarative markup language, such as XAML, enables a workflow where separate parties can work on the UI and the logic of an application. Workflow design application may alternatively be a visual workflow design application. For instance, a visual workflow design application such as Microsoft Visual Studio® may be utilized to create project workflows for shared services applications by creating project workflow activities and visually connecting the project workflow activities, for instance, either sequentially or via branches. In embodiments, the workflow design application 106 may include both visual design and declarative design capabilities.

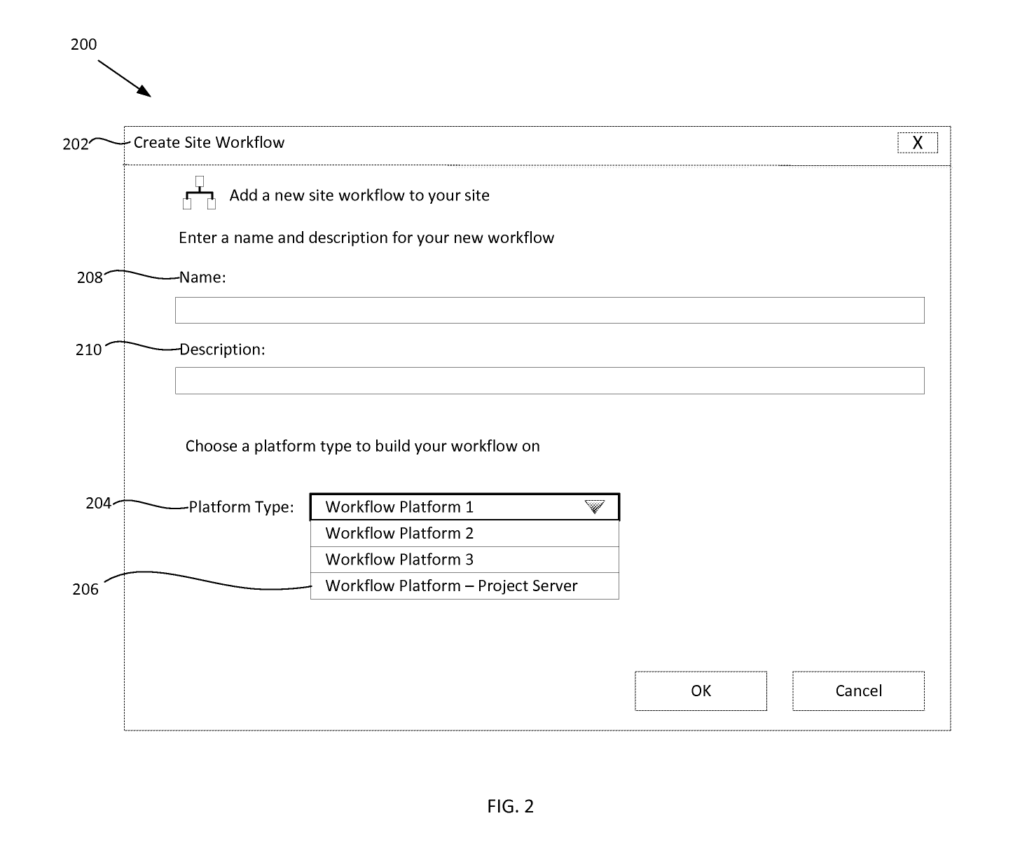

Workflow design application 106 provides an initial user interface for creating project workflows. User interface may display at least one selectable project workflow platform type upon verifying a connection between the workflow design application and a project server. For example, FIG. 2 illustrates an example of an initial user interface 200 for creating a project workflow according to one embodiment. In order to provide project workflow creation, a web application platform tool 102 may be capable of establishing a connection to the project server 104. The connection may be any suitable electronic connection (e.g., wired, wireless, etc.). Upon verifying the connection to the project server 104, the workflow design application 106 may recognize the project server 104, and the initial user interface 200 for a project workflow may be display one or more project type workflow platform types (e.g., Workflow Platform—Project Server 206) available for selection along with other, non-project workflow platform types. The initial user interface 200 may be accessed via a tab (e.g., a Create Site Workflow tab) displayed by the workflow design application 106 in a different screen (not shown). The initial user interface 200 may include a heading such as a “create a workflow” (e.g., “Create Site Workflow” heading 202 of FIG. 2). Workflow design application 106 may receive a platform type selection from a user. For instance, from user interface 200, a user may select the platform type drop down menu 204. For project workflow creation, the workflow design application may display a project server platform type menu selection among other, non-project workflow selections. For example, workflow design application 106 may display a selectable “Workflow Platform—Project Server ” platform type 206 from drop-down menu 204 or from an otherwise selectable list of available workflow platform types.

As stated above, workflow design application 106 may display the “Workflow—Project Server” platform type 206 upon verifying a connection between the web application platform tool 102(including the workflow design application 106), and the project server 104. For example, the following steps may occur in order to select a project server platform type. First, a connection validation script may run to ensure the project server 104 and the web application platform tool 102 are connected (e.g., able to communicate). A project server platform selection type menu 204 may then be displayed in the user interface 200. A project server platform type may be displayed as a selectable item among other, general purpose workflow platform types that are unrelated to projects or project servers (e.g., “Workflow Platform 1,” “Workflow Platform 2,” etc. in FIG. 2). Workflow design application 106 may then receive a project server platform type selection from a user (e.g., a “Workflow Platform—Project Server” platform type option 206). Workflow design application 106 may also receive name and description inputs. For instance, a name 208 and description 210 may be input for the workflow being created in addition to selecting a project server platform type.

When the workflow design application 106 recognizes that a user has begun the process of creating a project workflow with the workflow design application 106, for instance, by selection of a project server platform type 206, the project mode module 108 may be utilized to obtain project data from the project server 104 that is associated with the chosen project workflow platform type. For instance, when a user selects an available project server platform type 206, workflow design application 106 may retrieve from project server 104 (via project server API 116), and then display, one or more customizable project workflow components available for selection and modification. Project information, including data relating to the one or more customizable project workflow components, is retrieved from the project server 104 and received by the project mode module 108 to enable the workflow design application 106 to utilize the project data to create the project workflow. By making such information available to the workflow design application 106 through API 116, the project server 104 enables the user of a general-purpose workflow design application 106 to easily create project-related workflows using the same tools, and in a manner similar, to the way such user is accustomed to creating non-project workflows.

The workflow design application 106 may receive project data from a project server application programming interface (API) 116 capable of receiving project data requests from the project mode module 108, retrieving such data, and transferring the requested project data to the project mode module 108. The project server API 116 may be integrated into project server 104 to receive requests for project data and transfer project data to the project mode module 108.

The project server API 116 may be an interface for receiving requests for operations associated with one or more projects hosted on the project server 104. A project server API call may be sent by the project mode module 108 to request project workflow data. A project server API call may be a request to transfer project data from the project server 104 to the workflow design application 106. In conjunction with transferring project data to the workflow design application 106 in response to a project server API call, a determination may be made of at least one stored procedure associated with the project server API call. Stored procedures may include transferring one or more of project action information, a project stage information or project field information. The determined at least one stored procedure is validated, and the project server API 116 may then cause the determined stored procedure to be performed by the project server 104.

Using the project server API 116, project data may be retrieved from the project server 104. Project server 104 may include a project database 124 providing a data store for project data for one or more projects hosted on project server 104. The project server API 116 may be operably connected to the project database 124, and may obtain requested project data from the project database 124. Examples of project data include project action data, project stage data and project field information. For instance, project data may include data describing project tasks, project resources, project task assignments, project schedule, project costs, etc. Other examples of project data are possible. Project database 124 may also store definitions of project phases and project stages. Project database 124 may be incorporated into the project server 104, or may stand alone and be operably connected to the project server 104.

As stated previously, the project server API 116 is called by the workflow design application 106 to obtain project data from the project server. Project data may be provided to the web application platform tool 102 using, for instance, a XAML file for incorporation into the project workflow created via the workflow design application 106. In embodiments, the project data is then stored in the project mode module 108 of the workflow design application 106. Project mode module 108 may include one or more modules for retrieving and manipulating customizable project workflow components. Project mode module 108 provides a way for general-purpose workflow design application 106 to obtain the necessary project data stored in project server 104 to create project workflows therefrom. Project mode module 108 may include, for example, a project actions module 110, a project stage module 112, a project data lookup module 114, and other such interactive modules for retrieving and interacting with project data from the project server 104. Project data from the project server 104 may be received by to the project mode module 108 for use in creating a project workflow using the workflow design application 106.

To accomplish project workflow creation, project data may be added to one or more user interfaces of the workflow design application 106 for specifying one or more customizable project workflow components including project-related workflow actions, stages, parameters or variables. Customizable project workflow components may include readable constructs such as project action data 118, project stage data 120 and project field data 122. Such customizable project workflow components are not otherwise available in the general-purpose workflow design application, and the project mode module 108, in conjunction with project server API 116, permits such components to be accessible and usable through user interfaces presented by the workflow design application 106.

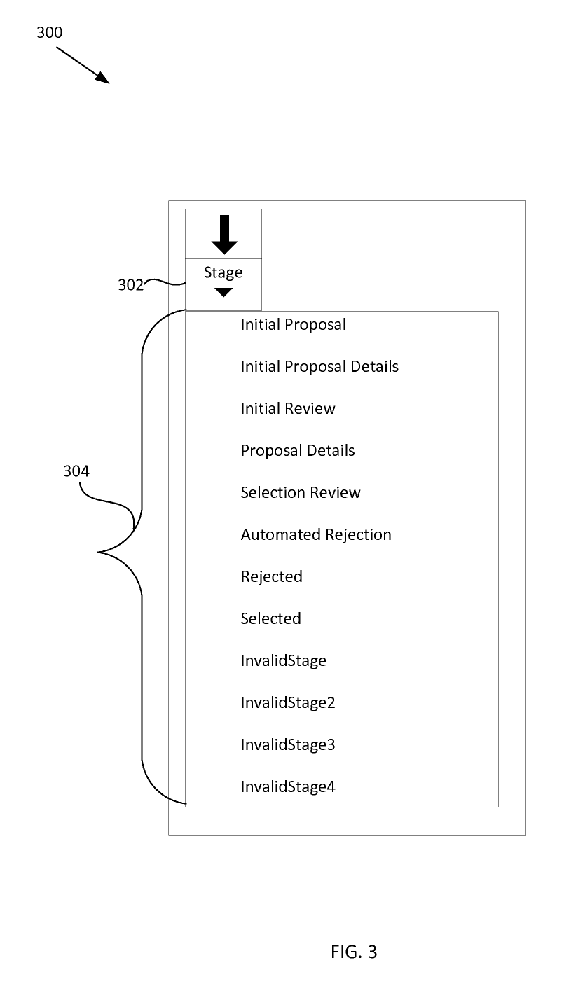

Project action data 118 may refer to data relating to one or more project actions available for execution within the project workflow. Project actions may be one or more project-related tasks requiring completion. Project stage data 120 refers to data relating to one or more distinct project objects that can be placed within the project workflow. A project stage may include a collection of project activities linked by common logic or theme. FIG. 3 further illustrates examples of stages further, including project stages with which the project stage data 120 may be associated. Project field data 122 may be data corresponding to one or more project workflow parameters and one or more project workflow variables associated with at least one action or at least one stage of a project workflow. Examples of parameter data include initiation parameter data for one or more initial parameters of the project workflow and data relating to one or more custom fields including, for example, a project workflow name, project workflow information, such as start date or end date.

Project stage data 120 may be requested, received by and stored in the project stages module 112. FIG. 3 shows user interface components 300 for displaying selectable project stage data available to be fetched from the project server 104 according to one embodiment. Workflow design application 106 may provide a stage user interface and receive and display one or more project stage selections. Project workflow creation may include use of one or more workflow stages, which may include use of project workflow stages received from the project server and general workflow stages available via the workflow design application 106. User interface components 300 may include a “Stage” user interface 302 on a tab of the workflow design application 102. Stage user interface 302 may be visible after a user has begun the process of creating a project workflow with the workflow design application 106. Workflow design application 106 may receive a Stage user interface selection made by a user. Workflow design application may then display a list of selectable workflow stages 304. Workflow stages 304 may incorporate a list of project-specific workflow stages into a list of standard workflow stages available to a user creating a workflow using the workflow design application 106. Certain of the displayed workflow stages 304 may be stages fetched from the project server 104 and made available for selection only when a project workflow is being created. Stages user interface 302 may also display one or more standard workflow stages that may be selected for use by the project workflow.

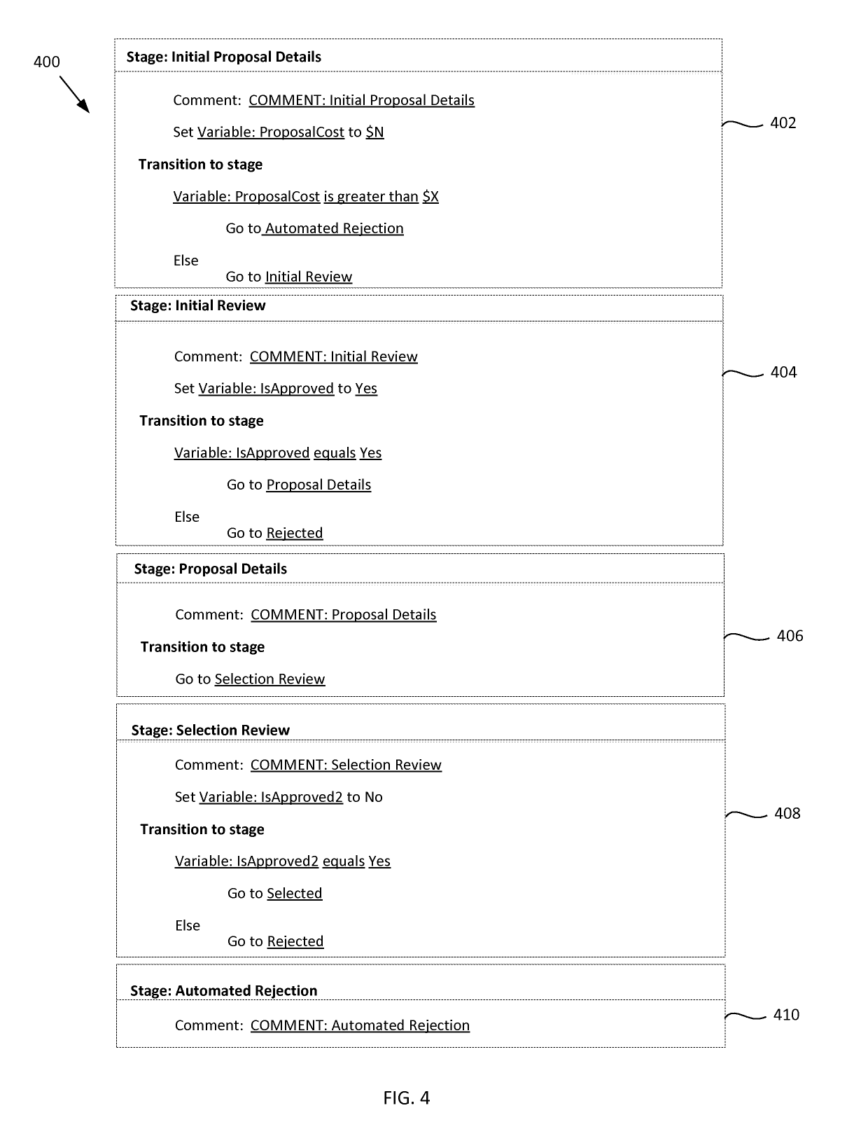

In embodiments, project stages may be selected and/or modified using sentence or visual based workflow logic. FIG. 4 shows a user interface 400 illustrating a series of sentence based project workflow logics according to one embodiment. Upon selecting one or more of the stages shown in FIG. 3, workflow design application 106 may display user interface 400. As shown in FIG. 4, user interface 400 may display one or more modifiable stages 402, 404, 406, 408, and 410. Stages 402, 404, 406, 408, and 410 may be selectable to input project-related stage parameters or variables defined in the project server 104, such as project workflow initial project details 402 (e.g., initial proposal details), initial review 404, further project details 406 (e.g., proposal details), further review 408 (e.g., selection review), and approval/rejection 410 (e.g., automated rejection). Workflow design application 106 may receive selections for one or more of the modifiable stages 402, 404, 406, 408, and 410 and utilize the selections to create the project workflow. It is contemplated that workflow stages may be retrieved from any external system and implementations of the present invention may not be limited to stages retrieved from project server 104.

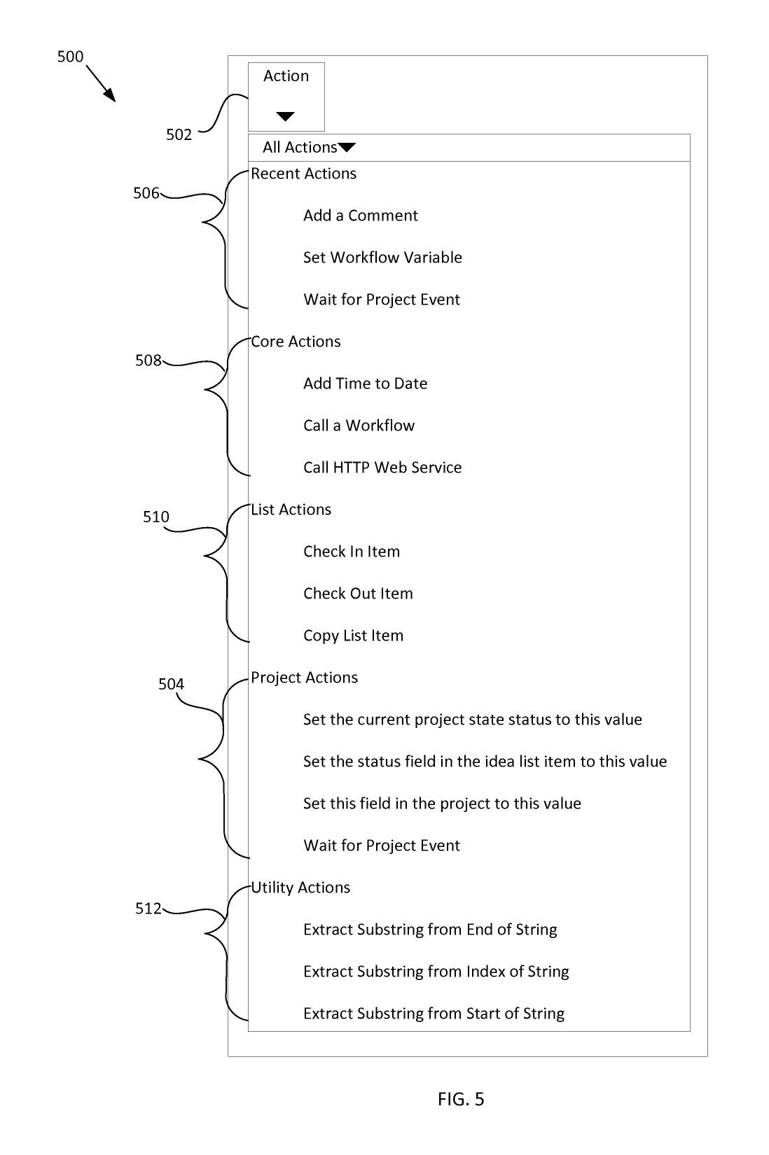

Project action data 118 may be requested, received by and stored in the project actions module 110. FIG. 5 shows user interface components 500 for displaying selectable actions including one or more selectable project actions according to one embodiment. A project workflow may include one or more workflow actions, which may include one or more project workflow actions 504 received by the project mode module from the project server and general workflow actions (e.g., 506, 508, 510, etc.) available via the workflow design application 106. User interface components 500 may include an “Action” user interface 502 displayed on a tab of the workflow design application 106. An action user interface selection may be received from a user. A list of selectable actions, including project workflow actions 504, may then be displayed. Project workflow actions 504 may be incorporated into a list of standard workflow actions 506, 508, 510, 512 available to a user creating a standard workflow using the workflow design application 106. A non-exhaustive list of standard actions may include one or more of “Recent Actions” 506, “Core Actions” 508, “List Actions” 510, and “Utility Actions” 512. Additional standard actions may also be displayed for selection.

Project field data 122 including one or more project workflow parameters and one or more project workflow variables may be requested, received by and stored in the project data lookup module 114. Project field data 122 may not require GUID verification prior to being received by the project mode module 108 of the workflow design application 106. Rather, the project data lookup module 114 may be utilized to obtain project field data from project server 104 (through project server API 116). In one embodiment, one or more parameters or variables of a project workflow may be called from the project server by the project data lookup module 114. Project data lookup module 114 may receive the one or more called parameters or variables from one or more data sources, including the project database 124, or a list, library, or existing workflow located on the project server 104. Project data lookup module 114 may employ data binding, wherein data across two or more data sources in a database, such as project database 124 are linked. Project data lookup module 114 may receive project data from the project server at initialization or runtime of the new project workflow, and may utilize the project data to perform one or more project workflow activities.

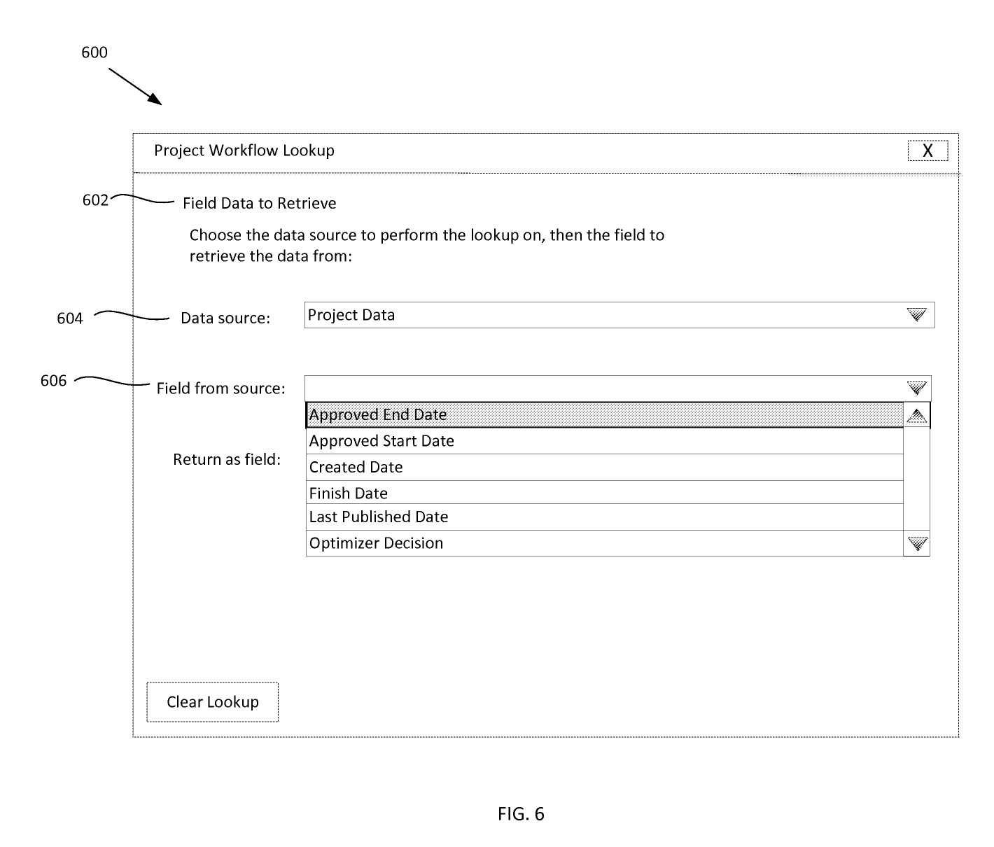

As stated previously, project data lookup module 114 may be utilized instead of requiring project data GUIDs to be determined prior to obtaining project field data 122 from the project server 104. Specifically, project data lookup module 114 may replace the use of GUIDs when fetching project objects such as actions, stages, or other project data for creation of the project workflow. Project data lookup module may display a project data lookup user interface 600 for receiving user selections of project data to retrieve while designing a workflow. FIG. 6 shows a project data lookup user interface 600 according to one embodiment. The project data lookup user interface 600 may query the project server API to retrieve project data such as project field data 122 without having to provide a GUID for the project field information. As shown in FIG. 6, project workflow lookup user interface 600 may provide a user interface for selecting field data to retrieve 602. Project workflow lookup user interface 600 may then receive a data source selection 604 from a user (e.g., a “Project Data” data source selection). The “Project Data” selection of a data source may represent data that is stored on a project server, such as project server 104. Other data sources may also be available from user interface 600, including data sources that are resident within web application platform tool 102 or other non-project related data sources. By integrating the project server 104 as a data source within user interface 600, a workflow designer using workflow design application 106 may craft a workflow that takes advantage of data available both inside and outside of the project server context without having to understand or locate GUIDs or other identifiers. Project workflow lookup user interface 600 may also present to the user and receive a selection of a source field 606 in the form of the one or more variables or parameters available from the project server, such as project server 104 through API 116. The user may also specify a “return field” that indicates the workflow field to which the returned variable or parameter should be written. Data source, field retrieval, and variable or parameter selection may be repeated to set variables and parameters as desired. This eliminates the labor-intensive process of manually gathering and inserting GUIDs for project objects into project workflow code in order for the project workflow to execute properly.

Project workflow may be created based on user selections of retrieved parameters and variables for one or more project actions and/or project stages. A project workflow may then be created in the workflow design application 106 based on the project data received from the project server 104. Specifically, upon receiving selections for one or more standard and/or project-specific workflow stages and actions, and receiving project field data selections (e.g., selections for one or more project workflow parameters, and one or more project workflow variables), workflow design application 106 may generate a project workflow. Selected parameters and variables may be set in a XAML file associated with the project workflow using the workflow design application 106. The project workflow may then be published to a web application platform. To this end, the XAML file may be formatted for executing the project workflow in the web application platform to allow manipulation of the project workflow within the web application platform. In addition, portions of a project workflow may be assigned a name and saved in a template project workflow database as a project workflow stage.

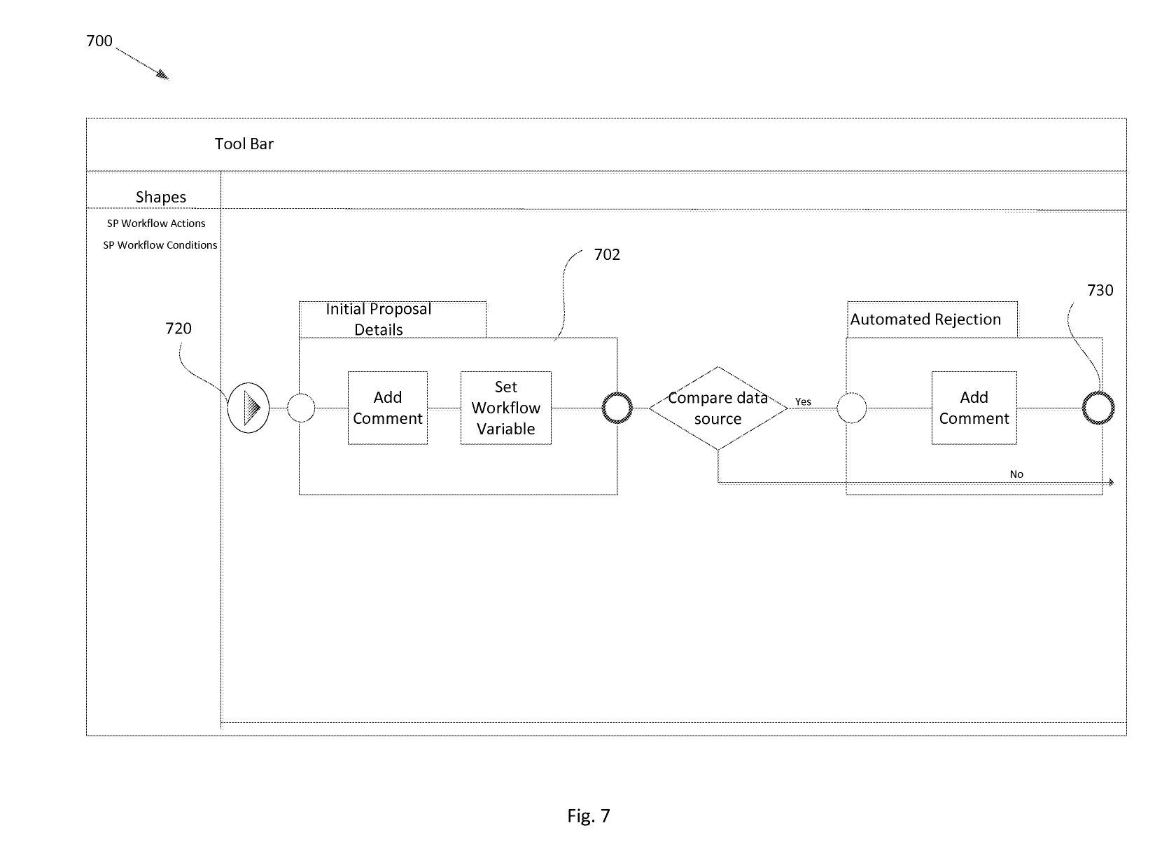

In some embodiments, a project workflow visualization for a project workflow may be generated. FIG. 7 illustrates a project workflow user interface 700 for visualization of a project workflow in stages, according to one embodiment. Project workflow visualization may include a simplified visualization of a project stage 702, and may further include start 704 and end 706 terminators. Workflow visualization is described in further detail in Application Docket Number 14917.1903US01/333726.01, entitled INTEGRATED WORKFLOW VISUALIZATION AND EDITING filed Dec. 9, 2011, and Application Docket Number 14917.1965USI1/334166.01, entitled STAGE AND STAGE VIEW WITHIN A WORKFLOW, filed Dec. 9, 2011, which are incorporated by reference in their entirety.

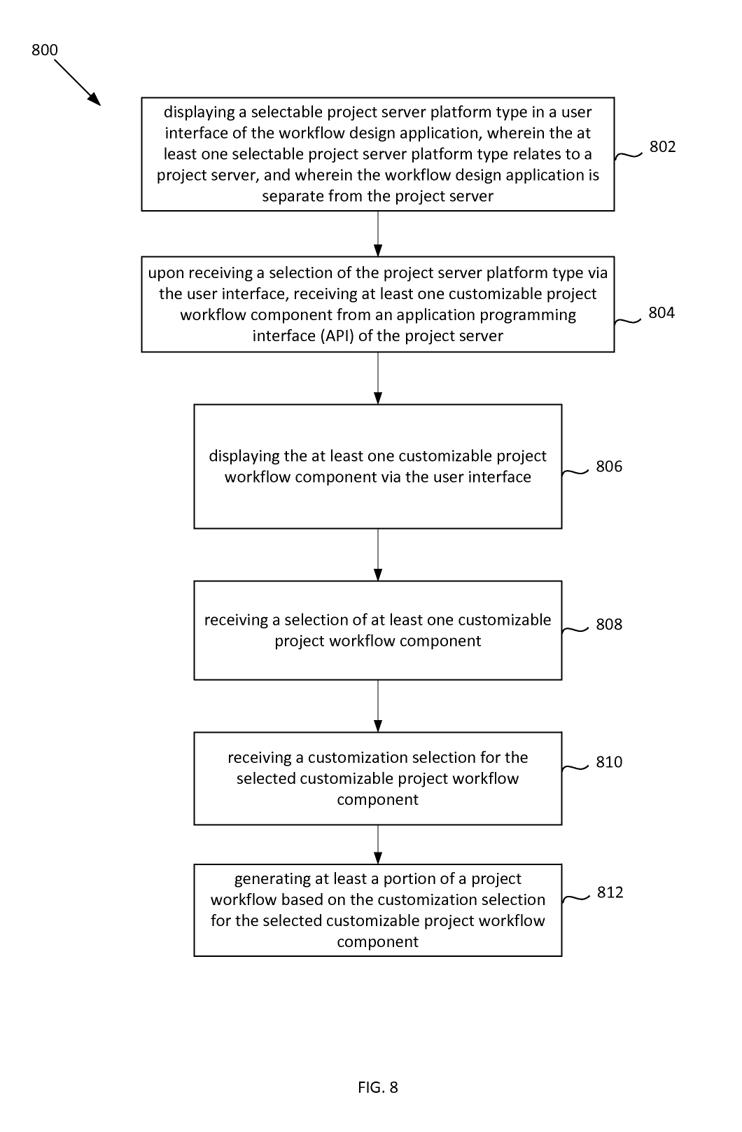

FIG. 8 is a flowchart of a method 800 for creating a project workflow according to one embodiment. Method 800 may be executed, for instance, via workflow design application 106, described above. Method 800 may alternatively be executed via any suitable system capable of creating a project workflow via a web application platform. Method 800 may include displaying 802 at least one selectable project server platform type in a user interface of the workflow design application. At least one project server platform type may be displayed among one or more non-project server platform types. In embodiments, this displaying 802 may occur only upon verifying a connection between the workflow design application and a project server. For instance, method 800 may generate a selectable icon representing a starting point for creating one or more project server workflows. Method 800 may include receiving 804 a selection of a project server platform type via the user interface. Method 800 may further include, upon receiving 804 a project server platform type selection, receiving 806 at least one customizable project workflow component from the project server via a project server application programming interface (API). Method 800 may further include displaying 808 the at least one customizable project workflow component via the user interface. Method may display the at least one customizable project workflow component among one or more non-project server related workflow components. For instance, method 800 may display one or more project actions or stages along with one or more non-project actions or stages, allowing a user to customize a project workflow to include one or more non-project related actions or stages as desired. Method 800 may also include receiving 810 selection of at least one customizable project workflow component. Method 800 may also include receiving 811 a selection of one or more customizations for the selected customizable project workflow component, and receiving a request to generate, and generating 812, at least a portion of a project workflow based on the customization selection for the selected customizable project workflow component. For example, if a particular project server is selected 804, the workflow design application may request and receive 806 a variety of workflow components available from such project server. The workflow design application may then receive a selection 808 of at least one of those workflow components and request and receive customizable options for such component(s). Such customization options may be selected 810, and used to generate 812 at least a portion of the workflow.

Customizable project workflow components may include one or more project server workflow items that may be added to a user interface for specifying workflow actions and stages. Method 800 may include storing and displaying customizable project workflow component data such as project action data, project stage data, and project field data in a project mode module of a workflow design application. Method 800 may store project action data in a project actions module of the project mode module. Method 800 may also store project stage data in a project stage module of the project mode module. Method 800 may store project field data in a project data lookup module of the project mode module. Method 800 may also utilize project data lookup module to request project field data. In one embodiment, method 800 may transmit a request to receive one or more parameters or variables of a project workflow from the project server via the project data lookup module and the project server API.

Method 800 may utilize a project data lookup module instead of requiring project data GUIDs to be determined prior to obtaining project field information from the project server. Project data may be received by the workflow design application as one or more a XAML files for incorporation into the project workflow created via the workflow design application. The project data may then be accessed in the web application platform tool by a workflow design application, and desired parameters may be set in the XAML file associated with the project workflow using the workflow design application. Method 800 may publish the project workflow to a web application platform to allow manipulation of the project workflow within the web application platform. Method may format the XAML file to enable execution of the project workflow in the web application platform and allow manipulation of the project workflow within the web application platform.

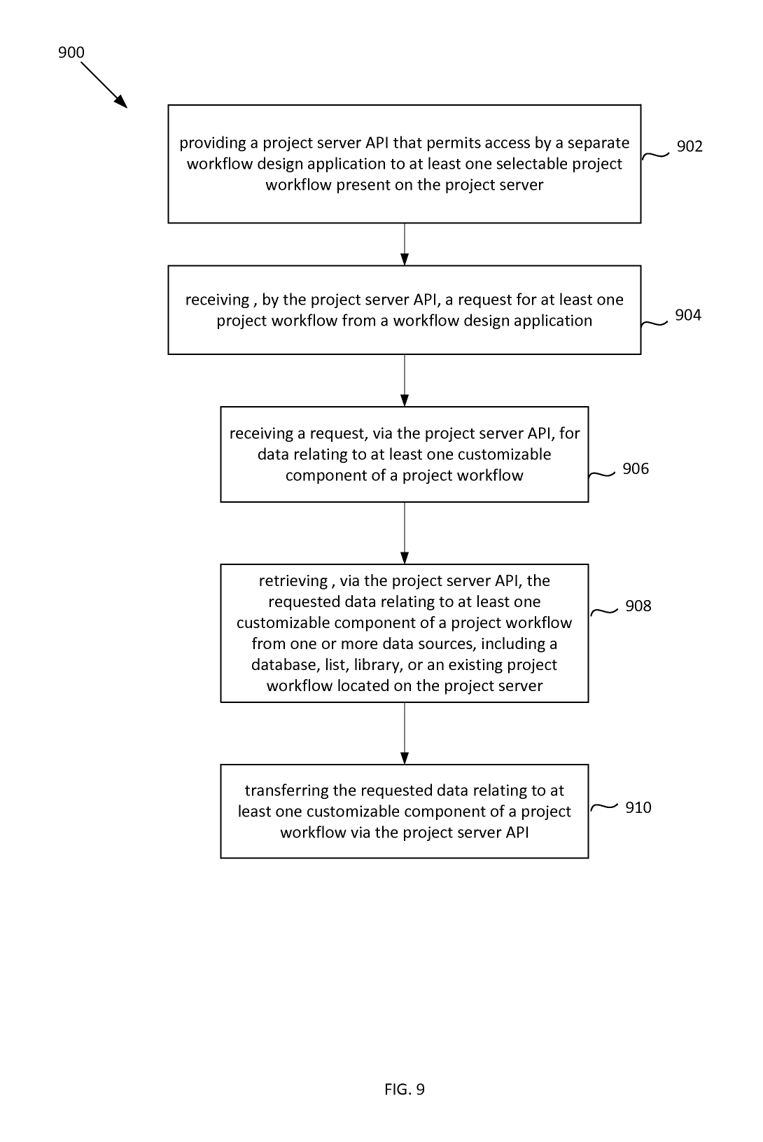

FIG. 9 is a flowchart of a method 900 for creating a project workflow according to one embodiment. Method 900 may be performed, in embodiments, by a project server using a project server API. Method 900 may also include providing 902 a project server API that permits access by a separate workflow design application to at least one selectable project workflow present on the project server. Method 900 may include receiving 904, by the project server API, a request for at least one project workflow from a workflow design application. Method 900 may further include receiving 906 a request, via the project server API, for data relating to at least one customizable component of a project workflow. Method 900 may include retrieving 908, via the project server API, the requested data relating to at least one customizable component of a project workflow from one or more data sources, including a database, list, library, or an existing project workflow located on the project server. Method 900 may further include transferring 910 the requested data relating to at least one customizable component of a project workflow via the project server API. The transferred data may include at least one of project action data, project stage data, and project field data relating to the project workflow.

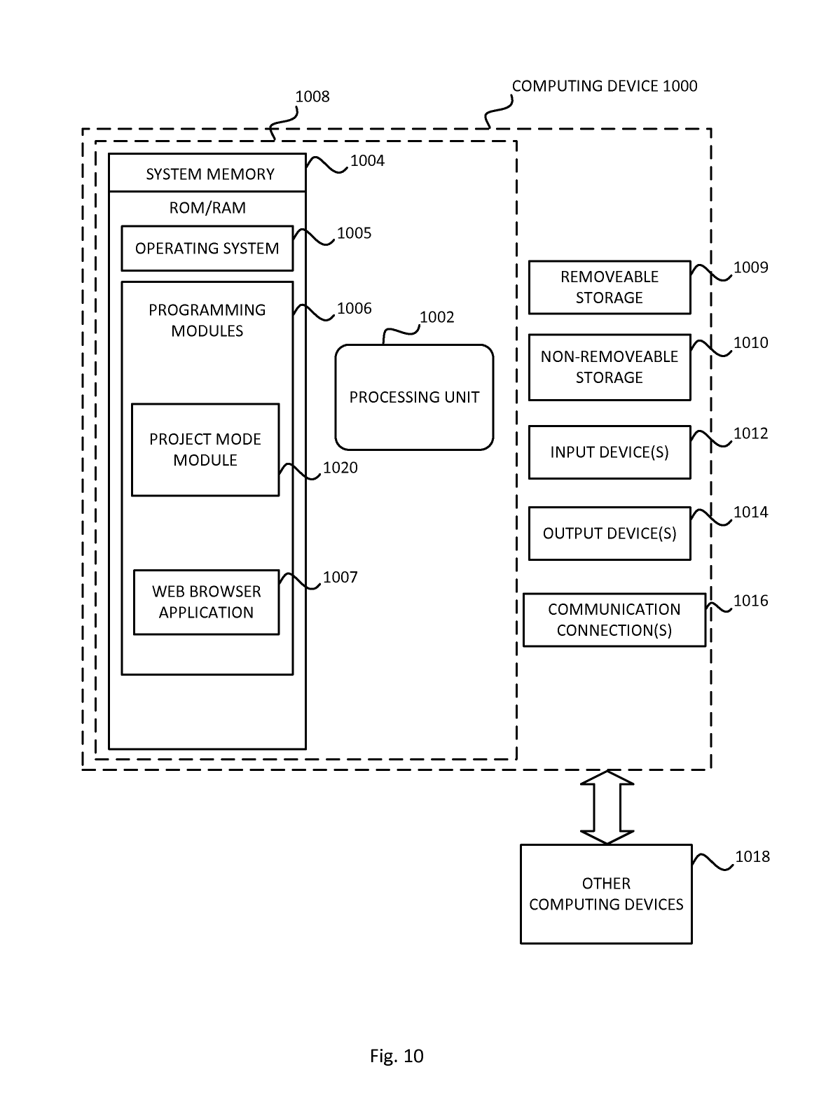

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 10 and its associated description provide a discussion of a variety of operating environments in which embodiments may be practiced. However, the devices and systems illustrated and discussed with respect to FIG. 10 are for purposes of example and illustration and are not limiting of a vast number of computing device configurations that may be utilized for practicing embodiments, described herein.

FIG. 10 is a block diagram illustrating example physical components of a computing device 1000 with which embodiments may be practiced. In a basic configuration, computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include operating system 1005, one or more programming modules 1006, and may include the project mode module 1020 for providing project workflow creation and editing. Operating system 1005, for example, may be suitable for controlling the operation of computing device 1000. Furthermore, embodiments may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010.

As stated above, a number of program modules and data files may be stored in system memory 1004, including operating system 1005. While executing on processing unit 1002, programming modules 1006, such as the project workflow module 1020, may perform processes including, for example, one or more of the processes described above with reference to FIGS. 1-9. The aforementioned processes are an example, and processing unit 1002 may perform other processes. Other programming modules that may be used in accordance with embodiments may include electronic mail and contacts applications, word processing applications, spreadsheet applications, database applications, slide presentation applications, drawing or computer-aided application programs, etc.

Generally, consistent with embodiments, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Furthermore, embodiments may be practiced in an electrical circuit comprising discrete electronic elements, packaged or integrated electronic chips containing logic gates, a circuit utilizing a microprocessor, or on a single chip containing electronic elements or microprocessors. For example, embodiments may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the project workflow module 1020 may be operated via application-specific logic integrated with other components of the computing device/system 1000 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Embodiments, for example, may be implemented as a computer process (method), a computing system, or as an article of manufacture, such as a computer program product or computer-readable storage medium. The computer program product may be a computer-readable storage medium readable by a computer system and encoding a computer program of instructions for executing a computer process.

The term computer-readable storage medium as used herein may include computer storage media. Computer storage media may include volatile and nonvolatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, etc. Output device(s) such as a display, speakers, a printer, etc. may also be included. The aforementioned devices are examples and others may be used.

Communication media may be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments herein may be used in connection with mobile computing devices alone or in combination with any number of computer systems, such as in desktop environments, laptop or notebook computer systems, multiprocessor systems, micro-processor based or programmable consumer electronics, network PCs, mini computers, main frame computers and the like. Embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments.

Embodiments, for example, are described above with reference to block diagrams and/or operational illustrations of methods, systems, and computer program products according to embodiments. The functions/acts noted in the blocks may occur out of the order as shown in any flowchart or described herein with reference to FIGS. 1-9. For example, two processes shown or described in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable storage media, such as secondary storage devices, like hard disks, floppy disks, a CD-ROM, or other forms of RAM or ROM. Further, the disclosed processes may be modified in any manner, including by reordering and/or inserting or deleting a step or process, without departing from the embodiments.

It will be apparent to those skilled in the art that various modifications or variations may be made to embodiments without departing from the scope or spirit. Other embodiments are apparent to those skilled in the art from consideration of the specification and practice of the embodiments disclosed herein.

What is claimed:

1. A system for creating a project workflow in a web application platform comprising:
a workflow design application capable of creating a workflow within a web application platform tool, further including:
a user interface for displaying, and receiving selection of, at least one project server platform type available for selection; and
a project mode module configured to retrieve at least one available customizable project workflow component from the project server via a project server application programming interface (API),
wherein the user interface is configured to display the retrieved at least one customizable project workflow component, receive at least one customizable project workflow component selection, receive a customization selection for the selected customizable project workflow component, and receive a request to generate at least a portion of a project workflow based on the customization selection for the selected customizable project workflow component.

2. The system of claim 1, wherein the at least one project server platform type available for selection is displayed among one or more non-project server workflow platform types.

3. The system of claim 1, wherein the project mode module includes a project actions module for receiving at least one available customizable project action from the project server and storing the at least one available customizable project action.

4. The system of claim 3, wherein the project actions module is configured to display the at least one available customizable project action in a list of actions integrated with one or more non-project related actions.

5. The system of claim 1, wherein the project mode module includes a project stages module for receiving at least one available customizable project stage from the project server and storing the at least one available customizable project stage.

6. The system of claim 1, wherein the project mode module includes a project data lookup module for receiving customizable project field data including at least one customizable project workflow variable and at least one customizable project workflow parameter from the project server and storing the customizable project field data.

7. The system of claim 6, wherein the project data lookup module executes a project data lookup user interface for displaying at least one available customizable project workflow parameter or at least one available customizable project workflow variable.

8. A method for creating project workflows in a workflow design application including:
displaying a selectable project server platform type in a user interface of the workflow design application, wherein the at least one selectable project server platform type relates to a project server, and wherein the workflow design application is separate from the project server;
upon receiving a selection of the project server platform type via the user interface, receiving at least one customizable project workflow component from an application programming interface (API) of the project server;
displaying the at least one customizable project workflow component via the user interface;
receiving a selection of at least one customizable project workflow component;
receiving a customization selection for the selected customizable project workflow component; and
generating at least a portion of a project workflow based on the customization selection for the selected customizable project workflow component.

9. The method of claim 8, wherein the displaying a selectable project server platform type in a user interface of the workflow design application includes displaying the selectable project server platform type among one or more non-project server workflow platform types.

10. The method of claim 8, wherein the receiving at least one customizable project workflow component selection includes:
receiving at least one available customizable project action from the project server and storing the at least one available customizable project action in a project actions module.

11. The method of claim 8, wherein the receiving at least one customizable project workflow component selection includes:
receiving at least one available customizable project stage from the project server and storing the at least one available customizable project stage in a project stages module.

12. The method of claim 11, further including displaying the received at least one available customizable project stage in a stages user interface of the workflow design application.

13. The method of claim 8, wherein the receiving at least one customizable project workflow component selection includes:
receiving at least one available customizable project action from the project server displaying the received at least one available customizable project action in a list of actions integrated with one or more non-project related actions.

14. The method of claim 8, wherein the receiving at least one customizable project workflow component selection includes:
receiving customizable project field data including at least one customizable project workflow variable and at least one customizable project workflow parameter from the project server and storing the customizable project field data in a project data lookup module.

15. The method of claim 13, further including utilizing the project data lookup module to obtain the customizable project field data instead of obtaining a globally unique identifier for the customizable project field data.

16. The method of claim 8, further including generating at least a portion of the project workflow and publishing the project workflow portion to a web application platform to allow manipulation of the project workflow portion within a web application platform.

17. A computer-readable storage medium including executable instructions that, when executed by a processor, provide project workflow creation, by:
displaying a selectable project server platform type among one or more non-project server platform types in a user interface of the workflow design application, wherein the at least one selectable project server platform type relates to a project server, and wherein the workflow design application is separate from the project server;
upon receiving a selection of the project server platform type via the user interface, receiving at least one customizable project workflow component from an application programming interface (API) of the project server;
displaying the at least one customizable project workflow component via the user interface;
receiving a selection of at least one customizable project workflow component;
receiving a customization selection for the selected customizable project workflow component;
generating at least a portion of a project workflow based on the customization selection for the selected customizable project workflow component; and
publishing the project workflow portion to a web application platform to allow manipulation of the project workflow portion within a web application platform.

18. The computer-readable storage medium of claim 17, wherein the receiving at least one customizable project workflow component selection includes:
receiving at least one available customizable project action from the project server and storing the at least one available customizable project action in a project actions module;
displaying the received at least one available customizable project action in a list of actions integrated with one or more non-project related actions.

19. The computer-readable storage medium of claim 17, wherein the receiving at least one customizable project workflow component selection includes:
receiving at least one available customizable project stage from the project server and storing the at least one available customizable project stage in a project stages module; and
displaying the received at least one available customizable project stage in a stages user interface of the workflow design application.

20. The computer-readable storage medium of claim 17, wherein the receiving at least one customizable project workflow component selection includes:
receiving customizable project field data including at least one customizable project workflow variable and at least one customizable project workflow parameter from the project server and storing the customizable project field data in a project data lookup module; and
displaying the customizable project field data in a project data lookup user interface.
